(19) United States
(12) Patent Application Publication
(10) Pub. No.: US 2026/0285052 A1
(43) Pub. Date: Sep. 24, 2026

(54) LIQUID CONVEYANCE DEVICE AND INKJET RECORDING APPARATUS

(71) Applicant: KYOCERA Document Solutions Inc., Osaka (JP)

(72) Inventor: Junichi FUKUOKA, Osaka (JP)

(73) Assignee: KYOCERA Document Solutions Inc., Osaka (JP)

(21) Appl. No.: 19/564,890

(22) Filed: Mar. 12, 2026

(30) Foreign Application Priority Data
Mar. 24, 2025 (JP) 2025-048532

(51) Int. Cl. B41J 2/175; B41J 2/17

(52) U.S. Cl. CPC B41J 2/17596; B41J 2/1721; B41J 2/17566

(57) ABSTRACT

A liquid conveyance device includes a flow path, a pump, a liquid leakage detection portion, a pump power supply circuit, and a latch circuit. The liquid leakage detection portion detects leakage of the liquid in the flow path and in the pump, and outputs a liquid leakage detection signal. The pump power supply circuit turns on and off a power supply for the pump. The latch circuit receives and holds the liquid leakage detection signal, and transmits the liquid leakage detection signal to the pump power supply circuit so as to cause the pump power supply circuit to turn off the power supply for the pump.

### INCORPORATION BY REFERENCE

This application is based on and claims the benefit of priority from Japanese Patent Application No. 2025-048532 filed on Mar. 24, 2025, the contents of which are hereby incorporated by reference.

### BACKGROUND

The present disclosure relates to a liquid conveyance device and an inkjet recording apparatus.

Inkjet recording apparatuses, which record an image on a sheet-shaped recording medium such as a paper sheet by ejecting ink onto it, are used widely as recording apparatuses such as printers and copiers due to their capability to record high-resolution images. In image forming apparatuses including inkjet recording apparatuses, measures are taken to monitor and detect liquid leakage in order to prevent contamination inside and outside the apparatus caused by leakage of liquids such as ink, cleaning liquid, and the like.

### SUMMARY

According to one aspect of the present disclosure, a liquid conveyance device includes a flow path, a pump, a liquid leakage detection portion, a pump power supply circuit, and a latch circuit. Through the flow path, liquid flows. The pump is connected to the flow path, and causes the liquid to move within the flow path. The liquid leakage detection portion detects leakage of the liquid in the flow path and in the pump, and outputs a liquid leakage detection signal. The pump power supply circuit turns on and off a power supply for the pump. The latch circuit receives and holds the liquid leakage detection signal, and transmits the liquid leakage detection signal to the pump power supply circuit so as to cause the pump power supply circuit to turn off the power supply for the pump.

### BRIEF DESCRIPTION OF THE DRAWINGS

FIG. 1 is a schematic vertical sectional front view of an inkjet recording apparatus according to one embodiment of the present disclosure.

FIG. 2 is a plan view of a recording portion and its surroundings of the inkjet recording apparatus shown in FIG. 1.

FIG. 3 is a diagram for illustrating configurations of an ink feed system and a control system around the recording portion of the inkjet recording apparatus shown in FIG. 1.

FIG. 4 is a diagram for illustrating configurations of an ink discharge system and a control system around the recording portion of the inkjet recording apparatus shown in FIG. 1.

FIG. 5 is a block diagram showing a configuration related to liquid leakage detection performed in the inkjet recording apparatus shown in FIG. 1.

FIG. 6 is a flowchart showing one example of a process of the liquid leakage detection performed in the inkjet recording apparatus shown in FIG. 1.

### DETAILED DESCRIPTION

Hereinafter, an embodiment of the present disclosure will be described with reference to the accompanying drawings. It should be understood that the present disclosure is not limited to the following descriptions.

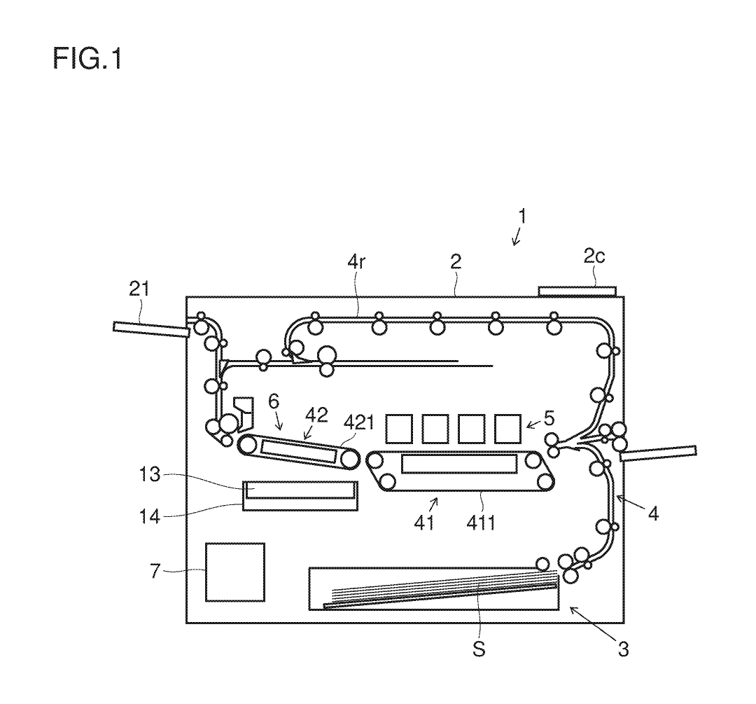

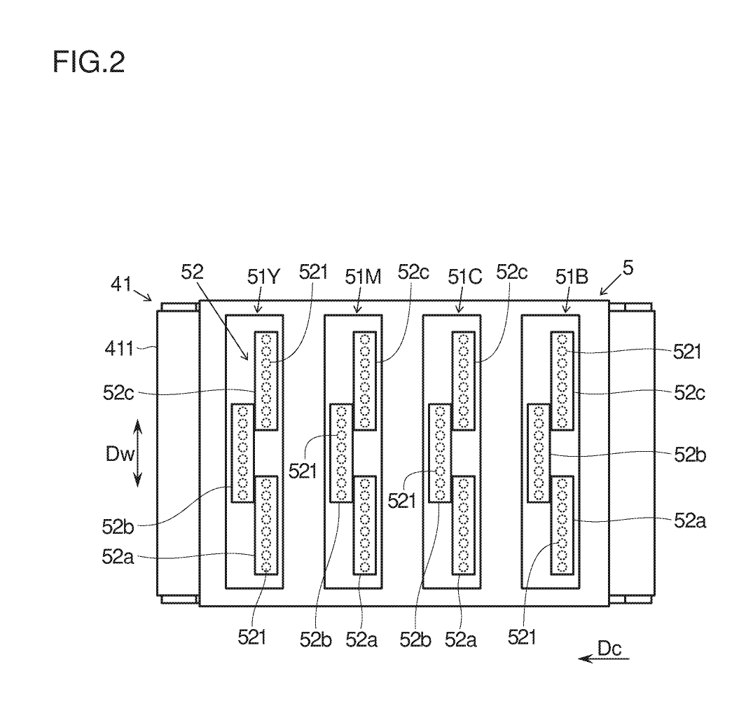

FIG. 1 is a schematic vertical sectional front view of an inkjet recording apparatus 1 according to an embodiment. FIG. 2 is a plan view of a recording portion 5 and its surroundings of the inkjet recording apparatus 1. The inkjet recording apparatus 1 is, for example, a printer that employs an inkjet recording method. As shown in FIGS. 1 and 2, the inkjet recording apparatus 1 includes an apparatus main body 2, a sheet feed portion 3, a sheet conveyance portion 4, the recording portion 5, a drying portion 6, and a control portion 7.

The sheet feed portion 3 is disposed in a lower part of the apparatus main body 2, for example. The sheet feed portion 3 contains a plurality of sheet (recording media) S, and feeds them separately, one by one, for recording.

The sheet conveyance portion 4 is disposed downstream of the sheet feed portion 3 in a sheet conveyance direction, and conveys a sheet S fed from the sheet feed portion 3. The sheet conveyance portion 4 conveys the sheet S to the recording portion 5 and the drying portion 6, and further discharge the sheet S to a sheet discharge portion 21 after the sheet S is subjected to recording and drying. The sheet conveyance portion 4 includes a reverse conveyance portion 4r, for example. In a case where double-sided recording is performed, the sheet conveyance portion 4 directs a sheet S into the reverse conveyance portion 4r after recording and drying is performed on a first side of the sheet S, and further, after turning over the sheet S by switching the sheet conveyance direction, the sheet conveyance portion 4 conveys the sheet S back to the recording portion 5 and the drying portion 6 again.

The sheet conveyance portion 4 includes a first belt conveyance portion 41 and a second belt conveyance portion 42. The first belt conveyance portion 41 includes a first conveyance belt 411, which is formed in an endless shape. The second belt conveyance portion 42 includes a second conveyance belt 421, which is formed in an endless shape. The first belt conveyance portion 41 and the second belt conveyance portion 42 convey a sheet S while holding the sheet S by suction on upper outer surfaces (top surfaces) of the first conveyance belt 411 and the second conveyance belt 421, respectively. The first belt conveyance portion 41 is disposed below the recording portion 5 and conveys the sheet S. The second belt conveyance portion 42, which is positioned downstream of the first belt conveyance portion 41 in the sheet conveyance direction, is disposed in the drying portion 6 and conveys the sheet S.

The recording portion 5 is positioned downstream of the sheet feed portion 3 in the sheet conveyance direction so as to face the first belt conveyance portion 41. The recording portion 5 faces the sheet S conveyed by being held by suction on the top surface of the first conveyance belt 411, and is disposed above the first conveyance belt 411 with a predetermined space therebetween. That is, the recording portion 5 faces the sheet S that is being conveyed by the sheet conveyance portion 4.

As shown in FIG. 2, the recording portion 5 holds head units 51B, 51C, 51M, and 51Y corresponding to four different colors of black, cyan, magenta, and yellow, respectively. The head units 51B, 51C, 51M, and 51Y are arranged side by side along a sheet conveyance direction Dc such that longitudinal directions thereof are parallel to a sheet width direction Dw, which is orthogonal to the sheet conveyance direction Dc. Note that the four head units 51B, 51C, 51M, and 51Y are identical in basic configuration, and thus in the following description, except in cases where specific color limitations are necessary, the identification symbols of “B”, “C”, “M” and “Y” representing their respective colors may be omitted.

The head units 51 corresponding to the different colors each include a recording head 52, which is a line-type inkjet recording head. As the recording head 52 in each of the head units 51 corresponding to the different colors, a plurality of (for example, three) recording heads 52 (52a, 52b, 52c) are arranged in a staggered manner along the sheet width direction Dw.

Each of the recording heads 52 includes a plurality of ink ejection nozzles 521 disposed at a bottom part thereof. The plurality of ink ejection nozzles 521 are arranged side by side along the sheet width direction Dw, and through them, ink can be ejected over an entire recording region on a sheet S. That is, the recording heads 52 each include a plurality of ink ejection nozzles 521 for ejecting ink onto a sheet S. The recording portion 5 ejects ink sequentially from the recording heads 52 of the head units 51B, 51C, 51M, and 51Y of the four different colors toward a sheet S conveyed by the first conveyance belt 411, thereby recording a full-color image or a monochrome image on the sheet S.

The drying portion 6 is disposed downstream of the recording portion 5 in the sheet conveyance direction and equipped with the second belt conveyance portion 42. In the drying portion 6, the sheet S, having an ink image recorded thereon in the recording portion 5, is conveyed while being held by suction on the second conveyance belt 421, during which the ink on its recorded surface is dried. After the drying, the sheet S is discharged to the sheet discharge portion 21.

The control portion 7 includes a CPU, a storage portion, and other electronic circuits and electronic components (of which none is illustrated). Based on control programs and data stored in the storage portion, the CPU controls operations of various constituent elements provided in the inkjet recording apparatus 1 to perform processing related to functions of the inkjet recording apparatus 1. The sheet feed portion 3, the sheet conveyance portion 4, the recording portion 5, and the drying portion 6 each individually receive instructions from the control portion 7 and execute recording on the sheet S in cooperation with each other. The storage portion is formed of a combination of, for example, a nonvolatile storage device such as a program ROM (read-only memory) or a data ROM and a volatile storage device such as a RAM (random-access memory).

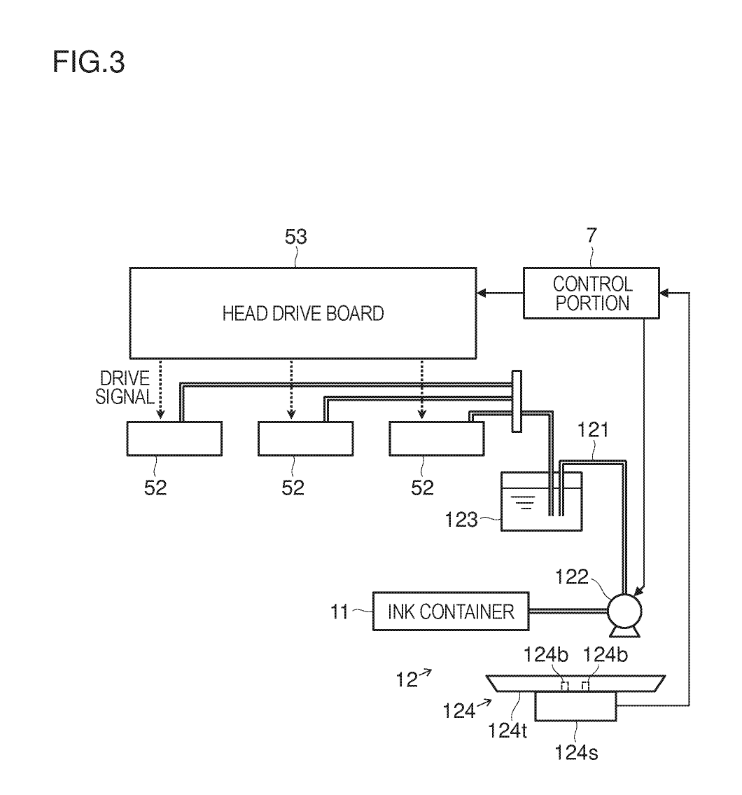

Next, a description will be given of a configuration of an ink feed system around the recording portion 5. FIG. 3 is a diagram for illustrating configurations of the ink feed system and a control system around the recording portion 5 of the inkjet recording apparatus 1 shown in FIG. 1. The inkjet recording apparatus 1 includes an ink container 11, an ink feed device (liquid conveyance device) 12, and a head drive board 53.

The ink container 11 is disposed so as to be attachable to and detachable from the apparatus main body 2. The ink container 11 stores ink to be supplied to a later-described sub-tank 123 of the ink feed device 12. The ink (liquid) within the ink container 11 is conveyed via the sub-tank 123 to the recording heads 52.

The ink feed device 12 feeds the ink stored in the ink container 11 to the recording heads 52. The ink feed device 12 includes a first flow path 121, a first pump 122, the sub-tank 123, and a first liquid leakage detection portion 124.

The first flow path 121 extends from the ink container 11 to the recording heads 52. That is, the first flow path 121 is disposed on an ink (liquid) feed side with respect to the recording heads 52. Within the first flow path 121, ink flows. Along the first flow path 121, the first pump 122 and the sub-tank 123 are arranged in order from an upstream side in an ink conveyance direction.

The first pump 122, which is connected to the first flow path 121, is disposed downstream of the ink container 11 in the ink conveyance direction. The first pump 122 causes the ink to move within the first flow path 121. More specifically, the first pump 122 sucks out the ink existing within the ink container 11 to eject it toward the sub-tank 123. Operations of the first pump 122 are controlled by the control portion 7.

The sub-tank 123 stores ink to be fed to the recording heads 52. The sub-tank 123 is equipped with an ink amount sensor (not shown). The control portion 7, which controls the first pump 122, controls an amount of ink to be fed from the ink container 11 to the sub-tank 123 by controlling operation time of the first pump 122. In a case where the first pump 122 has operated for a predetermined time but the amount of ink in the sub-tank 123 detected by the ink amount sensor does not rise above a predetermined amount, the control portion 7 determines that the ink container 11 is empty of ink. Note that the amount of ink stored in the sub-tank 123 is controlled so as to maintain a constant water head difference with respect to the recording heads 52.

The first liquid leakage detection portion 124 includes a liquid receiving tray 124t and a liquid leakage detection sensor 124s.

The liquid receiving tray 124t is disposed below the first flow path 121, the first pump 122, and the sub-tank 123, so as to cover an entire area below these elements or an area where there is a risk of liquid leakage. The liquid receiving tray 124t catches ink (liquid) leaking from a connection part of the first flow path 121, the first pump 122 itself, and the sub-tank 123 itself, for example.

The liquid leakage detection sensor 124s detects ink (liquid) that falls into the liquid receiving tray 124t to be stored therein. The liquid leakage detection sensor 124s includes two electrodes 124b that protrude into or are exposed inside the liquid receiving tray 124t. When liquid comes into contact with the two electrodes 124b, a current flows through the liquid, based on which the liquid leakage detection sensor 124s detects liquid leakage in the ink feed system via which ink is fed to the recording heads 52.

As has been described above, the liquid leakage detection sensor 124s detects ink (liquid) leakage in the first flow path 121 and in the first pump 122. Upon detecting ink (liquid) leakage, the liquid leakage detection sensor 124s outputs a liquid leakage detection signal to the control portion 7.

The head drive board 53 is disposed adjacent to the recording heads 52, and transmits a drive signal to each of the recording heads 52. The recording heads 52 each include a drive element (not shown) for driving the ink ejection nozzles 521. The head drive board 53 transmits a drive signal, having a predetermined drive waveform and a predetermined drive voltage, to the drive element of the ink ejection nozzles 521. The drive waveform of the drive element of the ink ejection nozzles 521 is prepared in advance according to a gradation value of a pixel (dot) of an image recorded by ejected ink droplets.

The control portion 7 controls the head drive board 53 and is capable of changing speed at which ink is ejected from the recording heads 52. In this manner, the control portion 7 controls operations of the recording heads 52 to record an image on a sheet S.

As shown in FIG. 1, the inkjet recording apparatus 1 further includes a maintenance unit 13. The maintenance unit 13 executes a maintenance process with respect to ink ejection surfaces of the recording heads 52 on which the ink ejection nozzles 521 are arranged. The maintenance unit 13 is supported by a unit movement mechanism 14 so as to be movable in a horizontal direction along the sheet conveyance direction. In a case where the maintenance process is not executed for the recording heads 52, the maintenance unit 13 is disposed at a first position, which is below the second belt conveyance portion 42, as shown in FIG. 1.

In the inkjet recording apparatus 1, the maintenance process for the recording heads 52 is executed at a predetermined timing. The maintenance process for the recording heads 52 is executed before starting recording after a long interval or between recording operations, for example. When executing the maintenance process for the recording heads 52, the control portion 7 causes the unit movement mechanism 14 to move the maintenance unit 13 to a second position, which is below the recording portion 5.

Note that, during the maintenance process for the recording heads 52, the first belt conveyance portion 41, which is disposed so as to face a lower surface of the recording portion 5, is moved by an unillustrated movement mechanism for the first belt conveyance portion 41 to a position that is below the position shown in FIG. 1 and that is near the sheet feed portion 3. Thereafter, the maintenance unit 13 is moved by the unit movement mechanism 14 to the second position below the recording portion 5 and is then moved to approach the ink ejection surfaces of the recording heads 52.

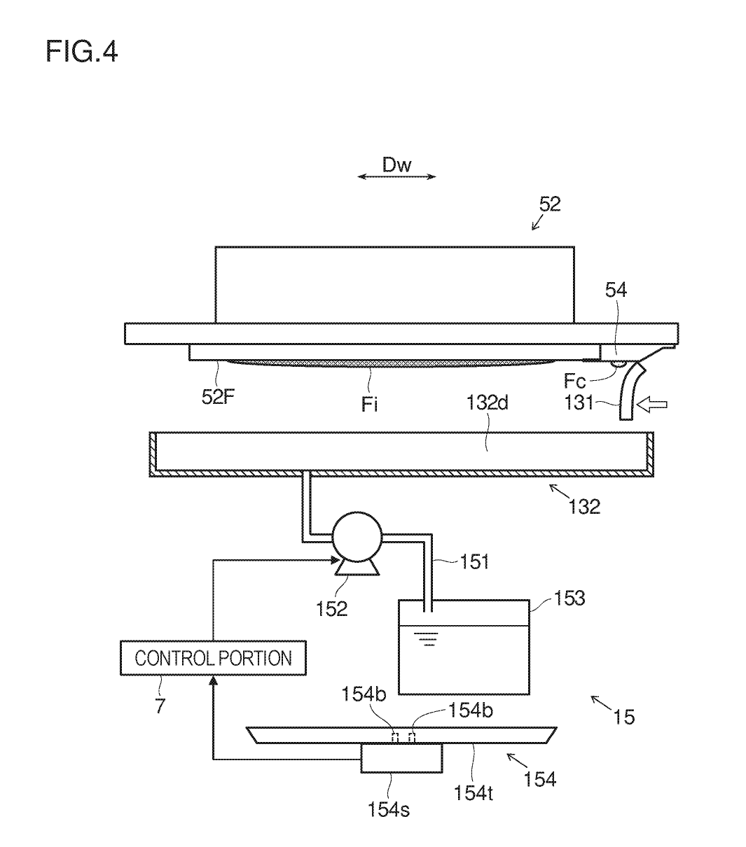

Next, a description will be given of a configuration of an ink discharge system around the recording portion 5. FIG. 4 is a diagram for illustrating the configurations of the ink discharge system and the control system around the recording portion 5 of the inkjet recording apparatus 1 shown in FIG. 1. The inkjet recording apparatus 1 includes a blade 131 and a waste liquid tray 132, which are equipped in the maintenance unit 13, and an ink discharge device (liquid conveyance device) 15.

The blade 131 is held by a holder (not shown) such that an edge thereof protrudes upward. The blade 131, which is made of rubber such as EPDM(ethylene-propylene-diene monomer) rubber or the like, is an elastic member having an edge at an upper end thereof extending substantially in the sheet conveyance direction. During the maintenance process for the recording heads 52, when the maintenance unit 13 approaches an ink ejection surface 52F of the recording heads 52, the blade 131 makes contact with the ink ejection surface 52F from below with a predetermined pressure, and moves along the sheet width direction Dw together with the holder that holds the blade 131.

Note that each of the recording heads 52 has a cleaning liquid feed portion 54 at one end of its ink ejection surface 52F in the sheet width direction Dw. During the maintenance process for the recording heads 52, a cleaning liquid Fc flows to a lower surface of the cleaning liquid feed portion 54. The cleaning liquid Fc is maintained, due to its surface tension, in a state of spreading over an entire area of the lower surface of the cleaning liquid feed portion 54.

Further, onto the ink ejection surface 52F, ink Fi is ejected from the ink ejection nozzles 521. The ink Fi, including ink having increased viscosity, foreign substances, bubbles, and the like existing within the ink ejection nozzles 521, for example, is forcibly pushed out of the ink ejection nozzles 521. The ink Fi is held, due to its surface tension, in a state of spreading over an entire area of a lower surface of the ink ejection surface 52F.

In this state, the blade 131 makes contact with the lower surface of the cleaning liquid feed portion 54 from below with a predetermined pressure. Thereafter, the blade 131 wipes off the cleaning liquid Fc from the lower surface of the cleaning liquid feed portion 54, and then conveys the cleaning liquid Fc to the ink ejection surface 52F. When conveyed by the blade 131 to the ink ejection surface 52F, the cleaning liquid Fc is mixed with the ink Fi held on the ink ejection surface 52F, and then wiped off.

The waste liquid tray 132 is disposed below the ink ejection surface 52F of the recording heads 52 so as to face the ink ejection surface 52F in an up-down direction. The waste liquid tray 132 is formed in a rectangular parallelepiped shape so as to be rectangular, in plan view, extending along the sheet conveyance direction and the sheet width direction Dw. The waste liquid tray 132 has a recessed portion 132d formed in an upper surface thereof so as to be recessed downward. During the maintenance process for the recording heads 52, the ink Fi and the cleaning liquid Fc having been wiped off from the ink ejection surface 52F by the blade 131 fall down into the recessed portion 132d to be collected therein.

The ink discharge device 15 discharges the ink (waste liquid) in the waste liquid tray 132 having been ejected from the recording heads 52. The ink discharge device 15 includes a second flow path 151, a second pump 152, a waste liquid tank 153, and a second liquid leakage detection portion 154.

The second flow path 151 extends from the waste liquid tray 132 to the waste liquid tank 153. That is, the second flow path 151 is disposed on an ink (liquid) discharge side with respect to the recording heads 52. Within the second flow path 151, ink (waste liquid) flows. At a position along the second flow path 151, the second pump 152 is disposed.

The second pump 152, which is connected to the second flow path 151, is disposed downstream of the waste liquid tray 132 in the ink conveyance direction. The second pump 152 causes ink to move within the second flow path 151. More specifically, the second pump 152 sucks out the ink existing within the waste liquid tray 132 and ejects it toward the waste liquid tank 153. Operations of the second pump 152 is controlled by the control portion 7.

The waste liquid tank 153 stores the ink Fi and the cleaning liquid Fc having been wiped off from the ink ejection surface 52F by the blade 131 and collected within the waste liquid tray 132 during the maintenance operation for the recording heads 52.

The second liquid leakage detection portion 154 includes a liquid receiving tray 154t and a liquid leakage detection sensor 154s.

The liquid receiving tray 154t is disposed below the second flow path 151, the second pump 152, and the waste liquid tank 153, so as to cover an entire area below these elements or an area where there is a risk of liquid leakage. The liquid receiving tray 154t catches ink (liquid) leaking from a connection part of the second flow path 151, the second pump 152 itself, and the waste liquid tank 153 itself, for example.

The liquid leakage detection sensor 154s detects ink (liquid) that falls into the liquid receiving tray 154t to be stored therein. The liquid leakage detection sensor 154s includes two electrodes 154b that protrude into, or are exposed inside, the liquid receiving tray 154t. When liquid comes into contact with the two electrodes 154b, an electric current flows through the liquid, based on which the liquid leakage detection sensor 124s detects liquid leakage in an ink discharge system via which ink is discharged from the recording heads 52.

As has been described above, the liquid leakage detection sensor 154s detects ink (liquid) leakage in the second flow path 151 and in the second pump 152. Upon detecting ink (liquid) leakage, the liquid leakage detection sensor 154s outputs a liquid-leakage detection signal to the control portion 7.

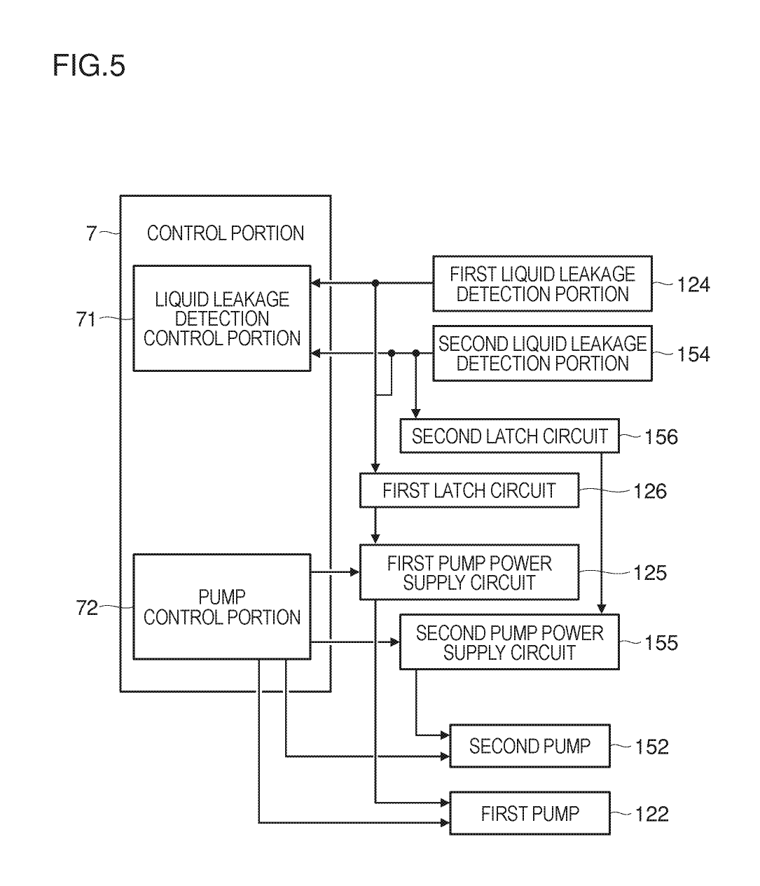

Next, signal transmission in the liquid leakage detection will be described. FIG. 5 is a block diagram showing a configuration related to the liquid leakage detection performed in the inkjet recording apparatus shown in FIG. 1.

The control portion 7 includes, as functional portions thereof, a liquid leakage detection control portion 71 and a pump control portion 72. In the present embodiment, the functions of the control portion 7 are executed by the CPU by performing arithmetic processing according to programs related to the liquid leakage detection and pump control, which are stored in the storage portion.

The ink feed device 12 further includes a first pump power supply circuit 125 and a first latch circuit 126. The ink discharge device 15 further includes a second pump power supply circuit 155 and a second latch circuit 156.

The liquid leakage detection control portion 71 performs various controls related to the liquid leakage detection based on liquid leakage detection signals received from the first liquid leakage detection portion 124 (the liquid leakage detection sensor 124s) of the ink feed device 12 and the second liquid leakage detection portion 154 (the liquid leakage detection sensor 154s) of the ink discharge device 15. For example, the liquid leakage detection control portion 71 transmits information regarding liquid leakage in the ink feed device 12 and in the ink discharge device 15 to the pump control portion 72.

Further, in a case where a liquid leakage detection signal has been received, the liquid leakage detection control portion 71 controls the first liquid leakage detection portion 124 or the second liquid leakage detection portion 154. More specifically, in the case where a liquid leakage detection signal has been received, the liquid leakage detection control portion 71 turns off a power supply for the first liquid leakage detection portion 124 or a power supply for the second liquid leakage detection portion 154. Further, in the case where a liquid leakage detection signal has been received, the liquid leakage detection control portion 71 displays information regarding the liquid leakage detection on an operation panel 2c disposed at an upper part of the apparatus main body 2 to notify a user that there is an abnormality in the ink feed system or in the ink discharge system.

The pump control portion 72 controls operations of the first pump 122 and operations of the second pump 152. More specifically, the pump control portion 72 controls turning on/off of the power supply for the first pump 122 and the power supply for the second pump 152 via the first pump power supply circuit 125 and the second pump power supply circuit 155. Further, the pump control portion 72 is also capable of controlling rotation speed, operation time, and the like of each of the first pump 122 and the second pump 152.

The first pump power supply circuit 125 and the second pump power supply circuit 155 respectively transmit, to the first pump 122 and the second pump 152, control signals regarding the power supplies for the respective pumps. For example, the first pump power supply circuit 125 transmits, to the first pump 122, a power supply-on signal and a power supply-off signal to turn on/off the power supply for the first pump 122. On the other hand, the second pump power supply circuit 155 transmits, to the second pump 152, a power supply-on signal and a power supply-off signal to turn on/off the power supply for the second pump 152.

The first latch circuit 126 and the second latch circuit 156 are each a self-holding circuit that maintains a signal input state. The first latch circuit 126 is wired such that its input side receives output signals from the first liquid leakage detection portion 124 and the second liquid leakage detection portion 154 and such that a signal is output from its output side to the first pump power supply circuit 125. The second latch circuit 156 is wired such that its input side receives an output signal from the second liquid leakage detection portion 154 and such that a signal is output from its output side to the second pump power supply circuit 155.

The first latch circuit 126 receives the liquid leakage detection signals of the first liquid leakage detection portion 124 and the second liquid leakage detection portion 154, and holds those signals. Furthermore, the first latch circuit 126 transmits the liquid leakage detection signals, which have been received from the first liquid leakage detection portion 124 and the second liquid leakage detection portion 154 and which have been held in the first latch circuit 126, to the first pump power supply circuit 125. Then, based on the liquid leakage detection signals, the first latch circuit 126 causes the first pump power supply circuit 125 to turn off the power supply for the first pump 122. That is, the first pump power supply circuit 125 turns off the power supply for the first pump 122 in a case where it has received, from the first latch circuit 126, the liquid leakage detection signals of the first liquid leakage detection portion 124 and the second liquid leakage detection portion 154.

The second latch circuit 156 receives the liquid leakage detection signal of the second liquid leakage detection portion 154, and holds the signal. Furthermore, the second latch circuit 156 transmits the liquid leakage detection signal of the second liquid leakage detection portion 154 that the second latch circuit 156 holds therein to the second pump power supply circuit 155. Then, based on the liquid leakage detection signal, the second latch circuit 156 causes the second pump power supply circuit 155 to turn off the power supply for the second pump 152. That is, the second pump power supply circuit 155 turns off the power supply for the second pump 152 in the case where the liquid leakage detection signal of the second liquid leakage detection portion 154 is received from the second latch circuit 156.

According to the configuration described above, in a case where ink (liquid) leakage has been detected, by the first latch circuit 126 and the second latch circuit 156 having received liquid leakage detection signals, the power supplies for the first pump 122 and the second pump 152 are turned off via the first pump power supply circuit 125 and the second pump power supply circuit 155. That is, even if, after liquid leakage has been detected, the first liquid leakage detection portion 124 or the second liquid leakage detection portion 154 malfunctions due to the detected liquid leakage such that its detection state is canceled, the first latch circuit 126 and the second latch circuit 156 maintain the detection state of the initially detected liquid leakage. In this manner, it is possible to stop the first pump 122 and the second pump 152 from restarting and thus to prevent ink conveyance from being restarted. Thus, it is possible to appropriately stop ink conveyance in the case where liquid leakage has been detected.

Further, in the case where a liquid leakage detection signal has been detected, the control portion 7 turns off the power supply for the first liquid leakage detection portion 124 and the power supply for the second liquid leakage detection portion 154. According to this configuration, immediately after liquid leakage has occurred, the power supply for the first liquid leakage detection portion 124 and the power supply for the second liquid leakage detection portion 154 are turned off. That is, if the first liquid leakage detection portion 124 and the second liquid leakage detection portion 154 remain powered even after liquid leakage has occurred, there is a risk that impurities may keep accumulating on the electrodes 124b and 154b to cause sensor malfunctions, but occurrence of such malfunctions can be prevented. Thus, it is possible to prevent damage to the liquid leakage detection sensors 124s and 154s.

The inkjet recording apparatus 1 includes, as liquid conveyance devices, the ink feed device 12, which feeds ink to the recording heads 52, and the ink discharge device 15, which discharges ink from the recording heads 52. According to this configuration, it is possible to maintain the occurrence states of liquid leakages independently detected in the ink feed system to the recording heads 52 and in the ink discharge system from the recording heads 52, and thus to stop restarting of the pumps. In this manner, the location of ink leakage can be identified, making it easy to determine where maintenance is required.

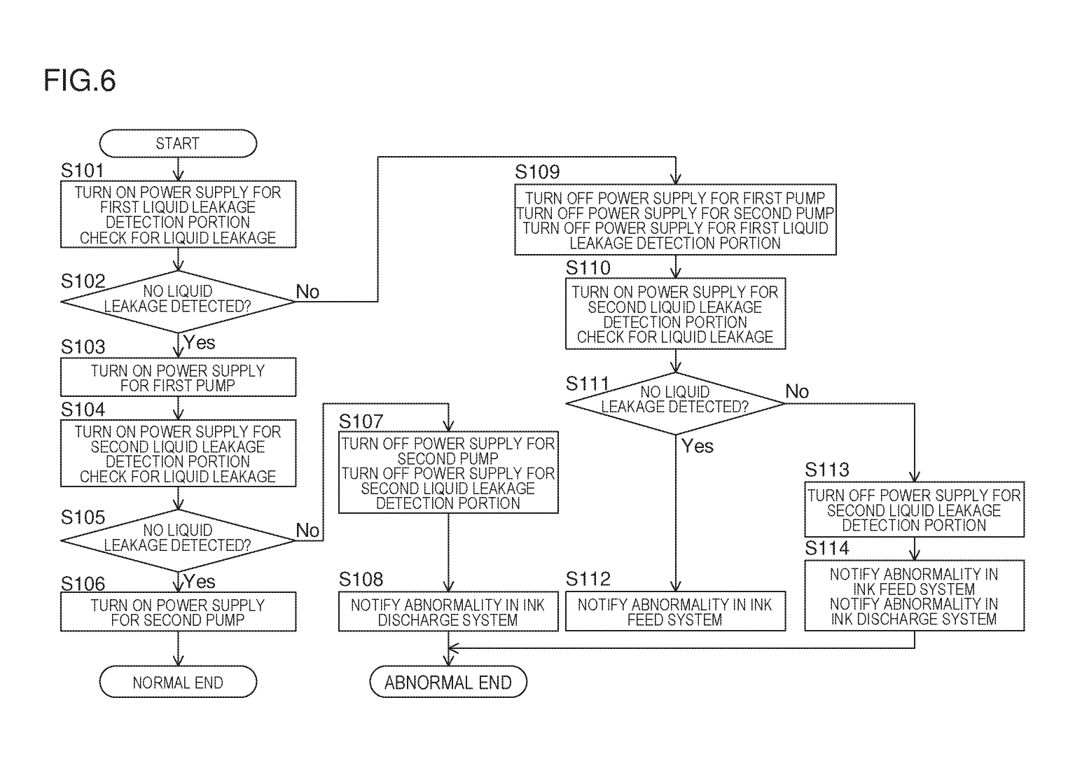

Next, a description will be given of one example of a flow of the detection of liquid leakage performed in the inkjet recording apparatus 1. FIG. 6 is a flowchart showing one example of a process of liquid leakage detection performed in the inkjet recording apparatus 1 shown in FIG. 1.

When the inkjet recording apparatus 1 is powered on (“START” in FIG. 6), in step S101, the control portion 7 turns on the power supply for the liquid leakage detection sensor 124s of the first liquid leakage detection portion 124, checks for liquid leakage in the ink feed system to the recording heads 52, and then proceeds to step S102.

In step S102, the control portion 7 determines whether liquid leakage has occurred in the ink feed system to the recording heads 52. In a case where no liquid leakage has occurred (Yes in step S102), the control portion 7 proceeds to step S103, where the control portion 7 turns on the power supply for the first pump 122.

In step S104, the control portion 7 turns on the power supply for the liquid leakage detection sensor 154s of the second liquid leakage detection portion 154, checks for liquid leakage in the ink discharge system from the recording heads 52, and then proceeds to step S105.

In step S105, the control portion 7 determines whether liquid leakage has occurred in the ink discharge system from the recording heads 52. In a case where no liquid leakage has occurred (Yes in step S105), the control portion 7 proceeds to step S106, where the control portion 7 turns on the power supply for the second pump 152. Then, the control portion 7 normally ends the process related to liquid leakage detection (“NORMAL END” in FIG. 6).

On the other hand, in a case where liquid leakage has occurred in the ink feed system to the recording heads 52 (No in step S102), the control portion 7 proceeds to step S109.

In step S109, the control portion 7 turns off the power supply for the first pump 122, turns off the power supply for the second pump 152, turns off the power supply for the liquid leakage detection sensor 124s of the first liquid leakage detection portion 124, and then proceeds to step S110.

In step S110, the control portion 7 turns on the power supply for the liquid leakage detection sensor 154s of the second liquid leakage detection portion 154, checks for liquid leakage in the ink discharge system from the recording heads 52, and then proceeds to step S111.

In step S111, the control portion 7 determines whether liquid leakage has occurred in the ink discharge system from the recording heads 52. In a case where no liquid leakage has occurred (Yes in step S111), the control portion 7 proceeds to step S112, where the control portion 7 displays liquid leakage detection information on the operation panel 2c disposed at the upper part of the apparatus main body 2 to thereby notify the user that there is an abnormality in the ink feed system. Then, the control portion 7 stores, in the storage portion, the information that there is an abnormality in the process related to liquid leakage detection, and ends the process (“ABNOMAL END” in FIG. 6).

On the other hand, in a case where liquid leakage has occurred in the ink discharge system from the recording heads 52 (No in step S111), the control portion 7 proceeds to step S113, where the control portion 7 turns off the power supply for the liquid leakage detection sensor 154s of the second liquid leakage detection portion 154, and then proceeds to step S114.

In step S114, the control portion 7 displays information regarding the liquid leakage detection on the operation panel 2c disposed at the upper part of the apparatus main body 2 to thereby notify the user that there is an abnormality in each of the ink feed system and the ink discharge system. Then, the control portion 7 stores, in the storage portion, the information that there is an abnormality in the process related to liquid leakage detection in the storage portion and ends the process (“ABNOMAL END” in FIG. 6).

Note that the liquid leakage detection process shown in FIG. 6 is repeatedly executed while the inkjet recording apparatus 1 is in operation.

According to the configuration described above, the driving of the first and second pumps 122 and 152 can be controlled by hardware, including the first latch circuit 126 and the second latch circuit 156 that hold the liquid leakage detection signals and transmit the signals to the first pump power supply circuit 125 and the second pump power supply circuit 155, and, in addition, by software of the control portion 7. Thus, it is possible to appropriately stop ink conveyance in a case where liquid leakage has been detected.

Although an embodiment of the present disclosure has been described above, it should be understood that the scope of the present disclosure is not limited thereto.

For example, in the above embodiment, the inkjet recording apparatus 1 includes the ink feed device 12 and the ink discharge device 15 as liquid conveyance devices that perform liquid leakage detection, but this configuration is not meant as a limitation. The inkjet recording apparatus 1 may be configured to include either the ink feed device 12 or the ink discharge device 15, or may be configured to further include another liquid conveyance device in addition to these.

What is claimed is:

1. A liquid conveyance device comprising:
a flow path through which liquid flows;
a pump that is connected to the flow path and that causes the liquid to move within the flow path;
a liquid leakage detection portion that detects leakage of the liquid in the flow path and in the pump and that outputs a liquid leakage detection signal;
a pump power supply circuit that turns on and off a power supply for the pump; and
a latch circuit that receives and holds the liquid leakage detection signal and that transmits the liquid leakage detection signal to the pump power supply circuit so as to cause the pump power supply circuit to turn off the power supply for the pump.

2. The liquid conveyance device according to claim 1, further comprising a control portion that controls the liquid leakage detection portion,
wherein
the control portion turns off a power supply for the liquid leakage detection portion in a case where the liquid leakage detection signal has been received.

3. An inkjet recording apparatus, comprising:
a recording head that ejects ink onto a recording medium; and
the liquid conveyance device according to claim 1 that feeds the ink to the recording head as the liquid.

4. An inkjet recording apparatus, comprising:
a recording head that ejects ink onto a recording medium; and
the liquid conveyance device according to claim 2 that feeds the ink to the recording head as the liquid.

5. The liquid conveyance device according to claim 2,
wherein
the flow path includes:
a first flow path disposed on a supply side of the liquid; and
a second flow path disposed on a discharge side of the liquid,
the liquid conveyance device includes:
a first pump that causes the liquid to move within the first flow path;
a first liquid leakage detection portion that detects leakage of the liquid in the first flow path and in the first pump and outputs a liquid leakage detection signal;
a second pump that causes the liquid to move within the second flow path; and
a second liquid leakage detection portion that detects leakage of the liquid in the second flow path and in the second pump and outputs a liquid leakage detection signal,
the control portion sequentially detects presence or absence of reception of the liquid leakage detection signal from the first liquid leakage detection portion and the second liquid leakage detection portion,
the control portion turns off a power supply for the first pump and a power supply for the second pump in a case where the liquid leakage detection signal has been received from the first liquid leakage detection signal, and
the control portion turns off the power supply for the second pump in a case where the liquid leakage detection signal has been received from the second liquid leakage detection portion.

6. An inkjet recording apparatus, comprising:
a recording head that ejects ink onto a recording medium; and
the liquid conveyance device according to claim 5 that feeds the ink to the recording head as the liquid and that discharges the ink having been ejected from the recording head,
wherein
the liquid conveyance device includes:
an ink feed device that includes the first flow path, the first pump, and the first liquid leakage detection portion, and that feeds the ink to the recording head; and
an ink discharge device that includes the second flow path, the second pump, and the second liquid leakage detection portion, and that discharges the ink from the recording head.
